(19) United States
(12) Patent Application Publication
(10) Pub. No.: US 2024/0381492 A1
(43) Pub. Date: Nov. 14, 2024

(54) HEATING DEVICE

(71) Applicant: BorgWarner Inc., Auburn Hills, MI (US)

(72) Inventors: Julio Casas, Nigrán (Pontevedra) (ES); José Viana, Nigrán (Pontevedra) (ES); Mauricio Muños, Nigrán (Pontevedra) (ES); Luis Ramírez, Nigrán (Pontevedra) (ES); Pablo Pais, Nigrán (Pontevedra) (ES)

(21) Appl. No.: 18/654,602

(22) Filed: May 3, 2024

(30) Foreign Application Priority Data
May 9, 2023 (EP) 23 172 379.2

(51) Int. Cl. H05B 1/02; H05B 3/22

(52) U.S. Cl. CPC H05B 1/0202; H05B 3/22; H05B 1/0236; H05B 2203/007; H05B 2203/021

(57) ABSTRACT

Disclosed is a heating device having a heating resistor assembly with a positive terminal, a negative terminal, and heating resistors connected in series between the positive terminal and the negative terminal, and a transistor switch connected in series with the heating resistors. A first half of the heating resistors connects the positive terminal to the transistor switch and a second half of the heating resistors connects the transistor switch to the negative terminal.

### RELATED APPLICATIONS

This application claims priority to EP 23 172 379.2, filed May 9, 2023, the entire disclosure of which is hereby incorporated herein by reference.

### BACKGROUND AND SUMMARY

This disclosure relates to a heating device, especially for an automobile, of the type generally known from, e.g., U.S. Publication No. 2022/0082297 A1.

Heating devices, like flow heaters, comprising a heating resistor assembly, e.g., a metallic heating plate with a resistive track, are used in automobiles for heating various fluids, e.g., air, water or aqueous solutions. As the on-board supply voltage of automobiles has been increased to several hundred volts, it is becoming more difficult to meet stringent requirements for electromagnetic compatibility, especially if the heating device is operated with a pulse width modulated voltage.

This disclosure shows how electromagnetic compatibility of a heating device for high voltage applications can be improved at low cost.

A heating device according to this disclosure comprises a heating resistor assembly which comprises a positive terminal, a negative terminal, and heating resistors connected in series between the positive terminal and the negative terminal.

According to this disclosure, electromagnetic emissions are minimized in such a way that a first half of the heating resistors connects a positive terminal of the heating resistor assembly to a transistor switch and a second half of the heating resistors connects the transistor switch to a negative terminal of the heating resistor assembly. The heating load is split into a first half and a second half arranged on a high side and a low side of the transistor switch, respectively. The transistor switch is arranged between the first half and the second half of the heating resistors. Parasitic capacitances of the heating load are thereby separated into parasitic capacitances of the first and the second half of the heating resistors and are thereby balanced.

When the transistor switch is open, parasitic capacitances between the first half of the heating load and the parasitic capacitances of the second half of the heating load are of opposite polarity so they are charged in opposite direction. When the transistor switch closes, the parasitic capacitances are discharged between them. The system is thereby balanced and currents charging and discharging the parasitic capacitances of each half of the heating load cancel each other to a large extent, reducing the common mode current generated by the system, especially if both halves of the heating load are electrically symmetrical. Radiated and conducted emissions are thereby greatly reduced and electromagnetic compatibility improved, which is especially important for heating devices in automobiles.

In a refinement of this disclosure, the heating resistor assembly is a heating plate comprising a metal sheet, on which the heating resistors are arranged as resistive tracks, and an insulation layer insulating the resistive tracks from the metal sheet. A first half of the resistive tracks then connects the positive terminal to the transistor switch and a second half of the resistive tracks connects the transistor switch to the negative terminal. Parasitic capacitances of the heating load are thereby separated into parasitic capacitances between the first half of the resistive tracks and the metal plate and parasitic capacitances between the second half of the tracks and the metal plate.

When the transistor switch is open, the parasitic capacitances between the first half of the tracks and the metal plate and the parasitic capacitances between the second half of the tracks and the metal plate are of opposite polarity so they are charged in opposite direction. When the transistor switch closes, the parasitic capacitances are discharged between them. The system is thereby balanced and the currents both charging and discharging of the parasitic capacitances of each half of the resistive tracks cancel each other to a large extent, reducing the common mode current generated by the system, especially if both halves of the resistive tracks are electrically symmetrical. Radiated and conducted emissions are thereby greatly reduced and electromagnetic compatibility improved. In a refinement of this disclosure, both halves of the resistive tracks load are physically or geometrically symmetrical. Thereby electrical symmetry can be achieved more easily to a larger extent.

As described above, the heating resistor assembly may be a heating plate with resistive tracks. In another embodiment of this disclosure, the heating resistor assembly may comprise PTC resistor plates or blocks, e.g., in heating rods of an air heater.

### BRIEF DESCRIPTION OF THE DRAWINGS

The above-mentioned aspects of exemplary embodiments will become more apparent and will be better understood by reference to the following description of the embodiments taken in conjunction with the accompanying drawings, wherein:

FIG. 1 shows an illustrative embodiment of a flow heater;

FIG. 2 shows a cross-sectional view of FIG. 1;

FIG. 3 shows a circuit diagram of the flow heater; and

FIG. 4 shows an example of a heating plate of the flow heater.

### DESCRIPTION

The embodiments described below are not intended to be exhaustive or to limit the invention to the precise forms disclosed in the following description. Rather, the embodiments are chosen and described so that others skilled in the art may appreciate and understand the principles and practices of this disclosure.

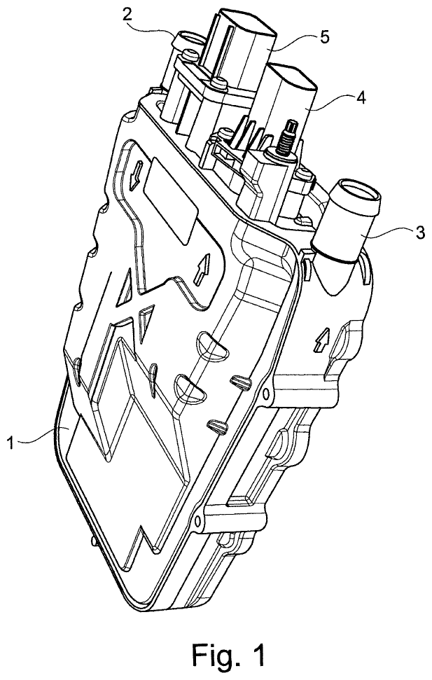

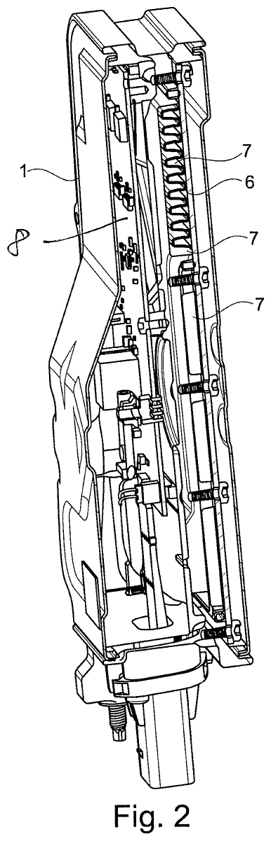

The heating device shown in FIGS. 1 and 2 is a flow heater for an automobile. The flow heater has a housing 1 with an inlet 2 and an outlet 3 as well as electrical connectors 4, 5 and a heating resistor assembly provided as a heating plate 6. A flow channel for liquid to be heated extends in the housing 1 from the inlet 2 to the outlet 3.

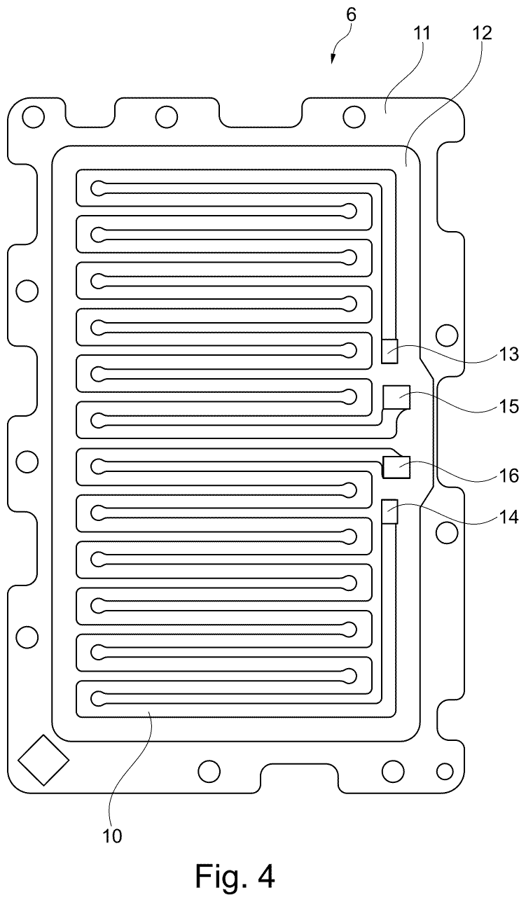

The flow channel runs along a heating plate 6. In order to improve heat dissipation to the liquid in the flow channel, the metal plate 6 may carry a corrugated sheet 7, which protrudes into the flow channel. On its dry side the heating plate 6 shown in FIG. 4 comprises heating resistors 10 provided in the as resistive tracks. In operation, heating current flows through these resistive tracks 10 of the heating plate 6. In a dry compartment of the housing 1 is control circuitry 8 for controlling heating power by pulse with modulation of heating current.

The heating resistors 10 of the heating plate 6 may be electrically connected to the control circuitry by means of press-fit contacts that are pressed into openings of a circuit board and soldered to the heating plate 6.

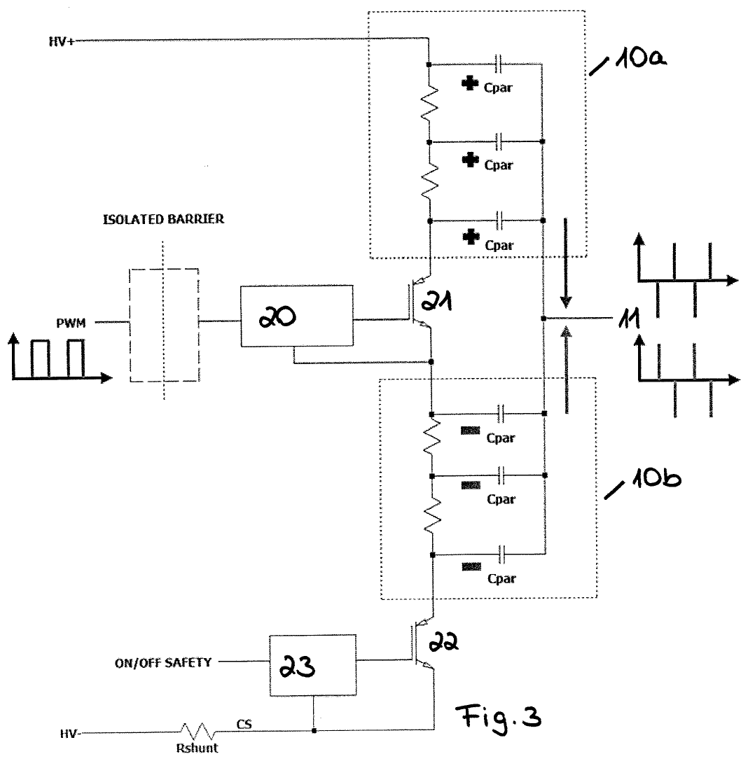

FIG. 3 shows schematically a circuit diagram of the flow heater that is configured to be operated at high voltage, e.g., voltage in the rage of 100 V to 1 kV. The control circuitry comprises a driver 20 that operates a transistor switch 21 for pulse width modulation. Switch 21 is a high side switch. While it is closed, a duty cycle of pulse width modulation is applied and heating current flows through a heating resistor provided as a resistive track of the heating plate 6. As can be seen in FIG. 3, the high side switch 21 splits the resistive tracks and thereby the heating resistors 10 into a first half 10a and a second half 10b. The switch 21 is arranged between the first half 10a and the second half 10b of the heating resistors. When switch 21 is open, the first half 10a of the heating resistors 10 is on positive potential and the second half of the heating resistors 10 is on negative potential. Both halves 10a, 10b form a capacitance with a metallic substrate 11 of the resistive tracks, e.g., a plate made of steel or aluminum. The metallic substrate 11 may be grounded by an electrical connection to mass.

Parasitic capacitances of the first half 10a of the resistive tracks and parasitic capacitances of the second half 10b of the resistive tracks are therefore charged with opposite polarity. Therefore, any radiated and conducted emissions caused by these parasitic capacitances are canceled to a large extent, especially if the heating plate 6 is designed symmetrically on both side of the transistor switch 21.

FIG. 4 shows an illustrative embodiment of the heating plate 6. The heating plate 6 comprises a metal sheet 11, e.g., a steel or aluminum sheet, as a substrate and heating resistors 10 provided as resistive tracks that are electrically insulated from the metal sheet 11 by means of an insulating layer 12 arranged between the metal sheet 11 and the resistive tracks. The resistive tracks might be printed onto the insulating layer 12 or deposited on it by other means, e.g., physical or chemical vapor deposition.

The heating plate 6 has a positive terminal 13 for connection to positive potential and a negative terminal 14 for connection to negative potential of a high voltage source. The positive terminal 13 and the negative terminal 14 are provided as solder pads at the ends of the resistive tracks such that a connection to circuit board 8 may be made by soldering a connector pin to the terminals 13, 14, e.g., as a surface mounted device.

The transistor switch 21 shown in FIG. 3 is electrically connected to solder pads 15, 16, e.g., by means of connector pins soldered to solder pads 15, 16 and may be arranged on printed circuit board 8. As can be seen in FIG. 4, a first half 10a of the resistive tracks runs from the positive terminal 13 to solder pad 15 and thereby electrically connects the positive terminal 13 to transistor switch 21 of FIG. 3. A second half 10b of the resistive tracks runs from solder pad 16 to the negative terminal 14 and thereby electrically connects the transistor switch 21 to the negative terminal 14.

The heating plate 6 may have a symmetrical design as shown in FIG. 4 to have electrical symmetry. Then the parasitic capacitances of the first half 10a and the second half 10b of the resistive tracks are balanced to the largest extent possible and emissions can thus be minimized.

In addition to the transistor switch 21 for pulse width modulation, the control circuitry may comprise a safety switch 22, e.g., a low side switch, that is operated by a driver 23, e.g., if overheating is detected.

While exemplary embodiments have been disclosed hereinabove, the present invention is not limited to the disclosed embodiments. Instead, this application is intended to cover any variations, uses, or adaptations of this disclosure using its general principles. Further, this application is intended to cover such departures from the present disclosure as come within known or customary practice in the art to which this invention pertains and which fall within the limits of the appended claims.

LIST OF REFERENCE SIGNS

| | |
|---|---|
| 1 | housing |
| 2 | inlet |
| 3 | outlet |
| 4 | electrical connector |
| 5 | electrical connector |
| 6 | heating plate |
| 7 | corrugated sheet |
| 8 | control circuitry |
| 10 | heating resistors |
| 10a | first half of heating resistors |
| 10b | second half of heating resistors |
| 11 | metal sheet |
| 12 | insulating layer |
| 13 | positive terminal |
| 14 | negative terminal |
| 15 | solder pad |
| 16 | solder pad |
| 20 | driver |
| 21 | transistor switch |
| 22 | safety switch |
| 23 | driver |

What is claimed is:

1. A heating device, comprising:
a heating resistor assembly having a positive terminal, a negative terminal, and heating resistors connected in series between the positive terminal and the negative terminal; and
a transistor switch connected in series with the heating resistors;
wherein, a first half of the heating resistors connects the positive terminal to the transistor switch and a second half of the heating resistors connects the transistor switch to the negative terminal.

2. The heating device according to claim 1, wherein the heating resistor assembly is a heating plate comprising a metal sheet, on which the heating resistors are arranged as resistive tracks, and an insulation layer insulating the resistive tracks from the metal sheet.

3. The heating device according to claim 2, further comprising a housing with an inlet and an outlet, wherein the heating plate is arranged inside the housing for heating liquid flowing from the inlet to the outlet.

4. The heating device according to claim 2, wherein the transistor switch is arranged inside the housing at a distance from the heating plate.

5. The heating device according to claim 2, wherein the heating resistors comprise a resistive layer printed onto the insulation layer.

6. The heating device according to claim 1, wherein the transistor switch is a high-side switch.

7. The heating device according to claim 1, wherein the first half of the heating resistors is electrically symmetrical to the second half of the heating resistors.

8. The heating device according to claim 1, further comprising control circuitry configured for operating the transistor switch for controlling heating power by pulse width modulation.

9. The heating device according to claim 1, further comprising a low side switch between the negative terminal heating resistor assembly and a negative terminal of the flow heater.
